(19) United States
(12) Patent Application Publication
(10) Pub. No.: US 2025/0174738 A1
(43) Pub. Date: May 29, 2025

(54) METHOD FOR PRODUCING ALL-SOLID-STATE BATTERY

(71) Applicants: Nissan Motor Co., Ltd., Kanagawa (JP); RENAULT S.A.S., Boulogne-Billancourt (FR)

(72) Inventors: Ryuji Shibamura, Kanagawa (JP); Kazuyuki Sakamoto, Kanagawa (JP); Harumi Takada, Kanagawa (JP)

(73) Assignees: Nissan Motor Co., Ltd., Kanagawa (JP); RENAULT S.A.S., Boulogne-Billancourt (FR)

(21) Appl. No.: 19/028,494

(22) Filed: Jan. 17, 2025

Related U.S. Application Data
(63) Continuation of application No. PCT/IB2022/000414, filed on Jul. 20, 2022.

(51) Int. Cl. H01M 10/42; H01M 10/0585

(52) U.S. Cl. CPC H01M 10/4235; H01M 10/0585

(57) ABSTRACT

A method for producing a lithium deposition type all-solid state battery having reliably suppressing short circuits is provided. The all-solid state battery includes a positive electrode, a negative electrode having a negative electrode current collector, a solid electrolyte layer interposed between the positive electrode and the negative electrode; and an intermediate layer interposed between the negative electrode current collector and the solid electrolyte layer, where the intermediate layer includes at least one type of a lithium reactive material. The method includes performing a first charging step on an uncharged all-solid state battery from an uncharged state to a capacity C₁[mAh/cm²], thereby forming an all-solid state battery precursor, and performing a second charging step on the all-solid state battery precursor from a capacity C₂ [mAh/cm²].

### TECHNICAL FIELD

One or more embodiments of the present invention relate to a method for producing an all-solid state battery.

### BACKGROUND

In recent years, research and development of all-solid state secondary batteries that use oxide- or sulfide-based solid electrolytes as electrolytes has been actively performed. The solid electrolyte is a material that is mainly composed of an ion conductor that is capable of conducting ions in a solid state. For this reason, all-solid state secondary batteries have the advantage that, in principle, various problems caused by flammable organic electrolyte solutions, as seen in conventional liquid lithium secondary batteries, do not occur.

One type of all-solid state battery known is a so-called lithium deposition type, in which lithium metal is deposited on the negative electrode current collector during a charging process. During the charging process of a lithium deposition type all-solid state secondary battery, lithium metal is deposited between the solid electrolyte layer and the negative electrode current collector. Through repeated charging and discharging, lithium metal can deposit into the gaps in the solid electrolyte, forming dendrites, which are branched crystals of lithium. Dendrites can cause short circuits in all-solid state batteries and the resulting decrease in capacity, and thus methods that can suppress the growth of dendrites are being investigated.

JP 2019-96610 A discloses a technique for providing a negative electrode active material layer (negative electrode intermediate layer) between a negative electrode current collector and a solid electrolyte layer, the negative electrode active material layer containing a negative electrode active material (for example, amorphous carbon, gold, platinum, palladium, silicon, silver, aluminum, bismuth, tin, or zinc) that forms an alloy or compound with lithium. With this structure, lithium metal is deposited between the negative electrode active material layer and the negative electrode current collector during charging. According to this literature, the negative electrode active material layer functions as a protective layer for the lithium metal layer and inhibits the growth of dendrites from the lithium metal layer, thereby making it possible to inhibit short circuits and capacity reduction in the all-solid state battery.

However, as a result of investigations by the inventors of the present invention, it has been found that even if the technique described in the above literature is applied, there is a case in which short circuits in all-solid state batteries cannot be sufficiently suppressed.

### SUMMARY

To address the above, a solution capable of more reliably suppressing short circuits in a lithium deposition type all-solid state battery is provided.

One or more embodiments of the present invention are a method for producing an all-solid state battery including a power generating element including: a positive electrode having a positive electrode active material layer containing a positive electrode active material capable of occluding and releasing lithium ions, disposed on a surface of a positive electrode current collector; a negative electrode having a negative electrode current collector in which lithium metal is deposited on the negative electrode current collector during charging; a solid electrolyte layer interposed between the positive electrode and the negative electrode and containing a solid electrolyte; and a negative electrode intermediate layer interposed between the negative electrode current collector and the solid electrolyte layer and containing at least one type of materials selected from the group consisting of materials capable of occluding and releasing lithium ions and metals capable of alloying with lithium. The production method includes a first charging step of charging an all-solid state battery precursor having the same configuration as that of the all-solid state battery and in an uncharged state to a capacity C₁ [mAh/cm²], and a second charging step of charging the all-solid state battery precursor that has undergone the first charging step from the capacity C₂[mAh/cm²]. Further, when a capacity of the lithium reactive material contained per unit area of the negative electrode intermediate layer is C. [mAh/cm²], a maximum value of a current density in the first charging step is I₁ [mA/cm²], and a minimum value of a current density in the second charging step is I₂ [mA/cm²] in plan view of the power generating element, 0.8×Cₓ [mAh/cm²]≤C₁ [mAh/cm²]≤C₂ [mAh/cm²] and I₁ [mA/cm²]<I₂ [mA/cm²] are satisfied.

### BRIEF DESCRIPTION OF THE DRAWING

FIG. 1 is a cross-sectional view schematically showing an overall structure of a laminated (internally parallel connection type) all-solid-state lithium secondary battery (laminate type secondary battery) according to one or more embodiments of the present invention.

### DETAILED DESCRIPTION

One or more embodiments of the present invention are a method for producing an all-solid state battery including a power generating element including: a positive electrode having a positive electrode active material layer containing a positive electrode active material capable of occluding and releasing lithium ions, disposed on a surface of a positive electrode current collector; a negative electrode having a negative electrode current collector in which lithium metal is deposited on the negative electrode current collector during charging; a solid electrolyte layer interposed between the positive electrode and the negative electrode and containing a solid electrolyte; and a negative electrode intermediate layer interposed between the negative electrode current collector and the solid electrolyte layer and containing at least one type of materials selected from the group consisting of materials capable of occluding and releasing lithium ions and metals capable of alloying with lithium. The production method includes a first charging step of charging an all-solid state battery precursor having the same configuration as that of the all-solid state battery and in an uncharged state to a capacity C₁ [mAh/cm²], and a second charging step of charging the all-solid state battery precursor that has undergone the first charging step from the capacity C₂[mAh/cm²]. Further, when a capacity of the lithium reactive material contained per unit area of the negative electrode intermediate layer is Cₓ [mAh/cm²], a maximum value of a current density in the first charging step is I₁ [mA/cm²], and a minimum value of a current density in the second charging step is I₂ [mA/cm²] in plan view of the power generating element, 0.8×Cₓ [mAh/cm²]≤C₁ [mAh/cm²]≤C₂[mAh/cm²] and I₁ [mA/cm²]<I₂ [mA/cm²] are satisfied. With the production method of the present embodiment, it is possible to more reliably suppress short circuits in a lithium deposition type all-solid state battery.

Hereinafter, first, the overall structure of the all-solid state battery produced by the production method according to the present embodiment will be described with reference to the attached drawings, and then the production method according to the present embodiment will be described. The technical scope of the present invention should be determined on the basis of the description of the claims, and is not limited only to the following forms.

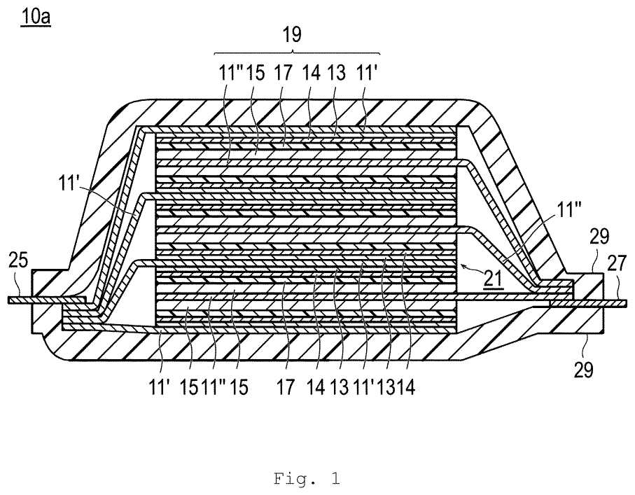

FIG. 1 is a cross-sectional view schematically showing an overall structure of a laminated (internal parallel connection type) all-solid-state lithium secondary battery (hereinafter, also simply referred to as a “laminate type secondary battery”) according to one or more embodiments of the present invention. FIG. 1 shows a cross section of a laminate type secondary battery during charging. A laminate type secondary battery 10a shown in FIG. 1 has a structure in which a substantially rectangular power generating element 21 in which a charge-discharge reaction actually proceeds is sealed inside a laminate film 29 that is a battery outer casing body. Herein, the power generating element 21 has a configuration in which a negative electrode, a solid electrolyte layer 17, and a positive electrode are laminated. The negative electrode has a structure in which a negative electrode current collector 11′, a negative electrode active material layer 13 made of lithium metal deposited on a surface of the negative electrode current collector 11′, and a negative electrode intermediate layer 14 containing silver nanoparticles and carbon black disposed between the negative electrode active material layer 13 and the solid electrolyte layer 17 are laminated. The positive electrode has a structure in which a positive electrode active material layer 15 is disposed on a surface of a positive electrode current collector 11″. The negative electrode, the solid electrolyte layer, and the positive electrode are laminated in this order such that the negative electrode intermediate layer 14 and the positive electrode active material layer 15 adjacent thereto face each other with the solid electrolyte layer 17 interposed therebetween. Thereby, the adjacent negative electrode, solid electrolyte layer, and positive electrode constitute one single battery layer 19. Therefore, it can be said that the laminate type secondary battery 10a shown in FIG. 1 has a configuration in which a plurality of single battery layers 19 are laminated to be electrically connected in parallel.

There is provided a structure in which a negative electrode current collecting plate 25 and a positive electrode current collecting plate 27, which are electrically connected to the respective electrodes (the negative electrode and the positive electrode), are respectively attached to the negative electrode current collector 11′ and the positive electrode current collector 11″, and are sandwiched between end parts of the laminate film 29 and led out of the laminate film 29. A confining pressure is applied to the laminate type secondary battery 10a in the lamination direction of the power generating element 21 by a pressurizing member (not illustrated). Therefore, the volume of the power generating element 21 is kept constant.

Hereinafter, main constituent members of the all-solid state battery according to the present embodiment will be described.

### [Current Collectors]

The current collectors (negative electrode current collector, positive electrode current collector) have a function of mediating transfer of electrons from the electrode active material layers. A material constituting the current collectors is not particularly limited. As a constituent material of the current collectors, for example, a metal such as aluminum, nickel, iron, stainless steel, titanium, or copper, or a resin having conductivity can be adopted. The thickness of the current collectors is also not particularly limited, and is, for example, 10 to 100 μm.

### [Negative Electrode Active Material Layer]

The all-solid state battery according to the present embodiment is of a so-called lithium deposition type in which lithium metal is deposited on a negative electrode current collector during a charging process. A layer made of lithium metal deposited on the negative electrode current collector during this charging process is the negative electrode active material layer of the lithium secondary battery according to the present embodiment. Therefore, the thickness of the negative electrode active material layer increases with the progress of the charging process, and the thickness of the negative electrode active material layer decreases with the progress of the discharging process. The negative electrode active material layer may not be present at the time of complete discharge, but in some cases, a negative electrode active material layer made of a certain amount of lithium metal may be disposed at the time of complete discharge. The thickness of the negative electrode active material layer (lithium metal layer) at the time of full charge is not particularly limited, but is typically 0.1 to 1000 μm.

### [Negative Electrode Intermediate Layer]

The negative electrode intermediate layer is a layer interposed between the negative electrode active material layer and the solid electrolyte layer, and contains a lithium reactive material. Examples of the lithium reactive material include a material capable of occluding and releasing lithium ions during charging and a metal capable of alloying with lithium during charging.

The material capable of occluding and releasing lithium ions is not particularly limited, but a carbon material may be preferable. Specific examples of the carbon material include carbon black (specifically, acetylene black, Ketjen black (registered trademark), furnace black, channel black, thermal lamp black, and the like), carbon nanotube (CNT), graphite, hard carbon, and the like. Among them, carbon black may be preferable, and at least one type selected from the group consisting of acetylene black, Ketjen black (registered trademark), furnace black, channel black, and thermal lamp black may be preferable.

Examples of the metal that can be alloyed with lithium include In, Al, Si, Sn, Mg, Au, Ag, Zn, and the like. Among them, In, Si, Sn, and Ag may be preferable, and Ag may be preferable.

The lithium reactive material may be used singly or in combination of two or more types thereof. As a form of using two or more types in combination, it may also be one embodiment to use a material capable of occluding and releasing lithium ions and a metal capable of alloying with lithium in combination. Thereby, sufficient strength and lithium-ion conductivity of the negative electrode intermediate layer can be secured. More specifically, nanoparticles made of In, Si, Sn, and Ag and carbon black may be used in combination, and nanoparticles made of Ag and carbon black may be used in combination. When the material capable of occluding and releasing lithium ions and the metal capable of alloying with lithium are used in combination, the blending ratio (mass ratio) thereof is not particularly limited, but the material capable of occluding and releasing lithium ions: the metal capable of alloying with lithium may be 10:1 to 1:1, or 5:1 to 2:1.

The content of the lithium reactive material in the negative electrode intermediate layer (when two or more types of materials are used in combination, it refers to the total content thereof, and the same applies hereinafter) is not particularly limited, but may be within a range of 50 to 100 mass %, within a range of 70 to 100 mass %, within a range of 85 to 100 mass %, or within a range of 90 to 100 mass %.

The negative electrode intermediate layer may be made of only a lithium reactive material as long as a free-standing film can be made of only a lithium reactive material, but may contain a binder as necessary. The type of binder is not particularly limited, and any binder known in the art can be appropriately used. Examples include polyvinylidene fluoride (PVDF) (including compounds in which hydrogen atoms are substituted with other halogen elements), polytetrafluoroethylene (PTFE), styrene-butadiene rubber (SBR), and carboxymethyl cellulose.

The content of the binder in the negative electrode intermediate layer is not particularly limited, but may be within a range of 1 to 15 mass %, or within a range of 5 to 10 mass %. If the binder content is 1 mass % or more, a negative electrode intermediate layer having sufficient strength can be formed. If the binder content is 15 mass % or less, a negative electrode intermediate layer having sufficient lithium-ion conductivity can be formed.

The thickness of the negative electrode intermediate layer is not particularly limited, but may be 1 to 50 μm, 5 to 40 μm, or 10 to 30 μm. When the thickness of the negative electrode intermediate layer is 1 μm or more, the function of the negative electrode intermediate layer can be sufficiently exhibited. When the thickness of the negative electrode intermediate layer is 50 μm or less, a decrease in energy density can be suppressed.

### [Solid Electrolyte Layer]

The solid electrolyte layer is interposed between the negative electrode and the positive electrode, and contains a solid electrolyte (typically as a main component). The solid electrolyte contained in the solid electrolyte layer is not particularly limited, and any solid electrolyte known in the art can be appropriately used. Examples include sulfide solid electrolytes such as LPS (Li₂S—P₂S₅), Li₆PS₅X (where X is Cl, Br, or I), Li₇P₃Su, Li_{3.2}P_{0.96}S, and Li₃PS₄. These sulfide solid electrolytes may be used because of having excellent lithium-ion conductivity and because of capable of following the volumetric changes of the electrode active material resulting from charging and discharging due to the volume modulus of the electrolytes being low.

The content of the solid electrolyte in the solid electrolyte layer may be 50 to 100 mass %, or 90 to 100 mass %.

The solid electrolyte layer may further contain a binder in addition to the solid electrolyte.

The thickness of the solid electrolyte layer varies depending on the intended configuration of the all-solid state battery, but may be 0.1 to 1000 μm, or 10 to 40 μm.

### [Positive Electrode Active Material Layer]

The positive electrode active material layer essentially contains a positive electrode active material, and may contain a binder and a conductive aid as necessary.

The type of the positive electrode active material contained in the positive electrode active material layer is not particularly limited, and examples thereof include layered rock salt type active materials such as LiCoO₂, LiMnO₂, LiNiO₂, LiVO₂, and Li(Ni—Mn—Co)O₂, spinel type active materials such as LiMn₂O₄ and LiNi_{0.5}Mn_{1.5}O₄, olivine type active materials such as LiFePO₄ and LiMnPO₄, Si-containing active materials such as Li₂FeSiO₄ and Li₂MnSiO₄, and the like. In addition, examples of an oxide active material other than the above include Li₄Ti₅O₁₂. Among these, Li(Ni—Mn—Co)O₂ and those in which a part of the transition metals is replaced by other elements (hereinafter also simply referred to as “NMC composite oxides”) may be used as the positive electrode active material.

In addition, using a sulfur-based positive electrode active material may be one embodiment. As sulfur-based positive electrode active materials, particles or thin films of organic sulfur compounds or inorganic sulfur compounds are exemplified, and may be a material that is capable of releasing lithium ions during charging and occluding lithium ions during discharging by utilizing the oxidation-reduction reaction of sulfur.

The content of the positive electrode active material in the positive electrode active material layer may be 50 to 100 mass %, 55 to 95 mass %, or 60 to 90 mass %.

The thickness of the positive electrode active material layer varies depending on the intended configuration of the all-solid state battery, but may be 0.1 to 1000 μm, 1 to 100 μm, or 10 to 40 μm.

Then, the production method according to the present embodiment will be described. The all-solid state battery produced by the production method according to the present embodiment is one that has undergone an initial charging step. In the present description, the structure to be subjected to the initial charging step is referred to as an “all-solid state battery precursor”. This “all-solid state battery precursor” is one that includes the same configuration as the all-solid state battery produced by the production method according to the present embodiment (specifically, it essentially has the above positive electrode current collector, positive electrode active material layer, solid electrolyte layer, negative electrode intermediate layer, and negative electrode current collector). The production method according to the present embodiment is roughly divided into a step 1 of preparing an all-solid state battery precursor having the above configuration, and a step 2 of subjecting the all-solid state battery precursor to initial charging. In addition, the initial charging step performed in the stage 2 essentially includes a first charging step and a second charging step (the details of which will be described later). By this initial charging step, charging is performed from the uncharged state after the stage 1 to a fully charged state. After this initial charging step, a discharging step, which is an optional step, may be further performed. The production method according to the present embodiment is one that has characteristics in the stage 2, in which an initial charging step (and a discharging step, as necessary) is performed on the all-solid state battery precursor. Meanwhile, since the method for preparing the all-solid state battery precursor in the stage 1 is not particularly limited, detailed description of the stage 1 will be omitted.

### [Initial Charging Step (First Charging Step and Second Charging Step)]

The stage 2 of the production method according to the present embodiment essentially includes a first charging step of charging the all-solid state battery precursor having the above configuration to a capacity C₁ [mAh/cm²], and a second charging step of charging the all-solid state battery precursor that has been subjected to the first charging step from a capacity C₂ [mAh/cm²]. The first charging step and the second charging step are characterized in that, when the power generating element is viewed in plan view, the capacity of the lithium reactive material contained per unit area of the negative electrode intermediate layer is C. [mAh/cm²], the maximum current density in the first charging step is I₁ [mA/cm²], and the minimum current density in the second charging step is I₂ [mA/cm²], a formula 1:0.8×Cₓ: [mAh/cm]≤C₁ [mAh/cm)≤C₂[mAh/cm] and a formula 2: I₁ [mA/cm²]<I₂ [mA/cm] are satisfied. By including these steps, a more reliable effect of suppressing short circuits can be achieved in a lithium deposition type all-solid state battery. Although the detailed mechanism is unclear, the inventors of the present invention assume the following. Note that the following mechanism is merely an assumption and does not limit the technical scope of the present invention.

The all-solid state battery precursor produced in the step 1 is in an uncharged state (a state in which lithium is not contained in the lithium reactive material contained in the negative electrode intermediate layer (more specifically, a state in which lithium is not occluded in a material capable of occluding and releasing lithium ions, and a state in which lithium is not alloyed in a metal capable of alloying with lithium)). Herein, lithium ions move from the positive electrode to the negative electrode for the first time in the initial charging step (more specifically, the first charging step) of the stage 2. At that time, the lithium reactive material contained in the negative electrode intermediate layer reacts electrochemically with the lithium ions. Since the lithium reactive material after reacting with the lithium ions has lithium-ion conductivity, the lithium ions become able to move in the negative electrode intermediate layer by performing the charging step in the step 2. Then, when the lithium reactive material contained in the negative electrode intermediate layer has completely reacted with the lithium ions, deposition of lithium metal begins on the negative electrode current collector side beyond the negative electrode intermediate layer. The details of formulas 1 and 2 will be described later, and in summary, in the first charging step of the production method according to the present embodiment, at least 80% of the total amount of lithium ions with which the lithium reactive material contained in the negative electrode intermediate layer can react is supplied to the negative electrode side (the technical significance of the formula 1). This allows a sufficient amount of the lithium reactive material to react with lithium ions to impart lithium-ion conductivity to the negative electrode intermediate layer. In addition, in the first charging step, charging is performed at a relatively low charging density (low rate) compared to the second charging step (technical significance of the formula 2). This inhibits localized reaction between the lithium reactive material and the lithium ions. As a result, lithium-ion conductivity is uniformly imparted to the negative electrode intermediate layer in the first charging step, and the lithium metal (negative electrode active material layer) deposited in the subsequent second charging step becomes more uniform. In addition, since the strength in the negative electrode intermediate layer is also uniform, even when minute dendrites are generated in the lithium metal (negative electrode active material layer), the growth thereof is suppressed. Therefore, in the lithium deposition type all-solid state battery, a more reliable short-circuit suppression effect can be exhibited. In the first charging step and the second charging step described in detail below, not the absolute value of the current density but only the relative relationship of the current density is defined. This is because the required current density varies depending on the intended configuration of the all-solid state battery, and thus the essence of the present invention cannot be expressed using the absolute value of the current density.

Hereinafter, the formulas 1 and 2 will be described in detail.

$$0.8 \times {C}_{x} [ mAh / {cm}^{2} ] \leq {C}_{1} [ mAh / {cm}^{2} ] \leq {C}_{2} [ mAh / {cm}^{2} ] \qquad Formula 1$$

$${I}_{1} [ mA / {cm}^{2} ] < {I}_{2} [ mA / {cm}^{2} ] \qquad Formula 2$$

In the formula 1, C. [mAh/cm²] represents the capacity of the lithium reactive material contained per unit area of the negative electrode intermediate layer when the power generating element is viewed in plan view. In other words, when the all-solid state battery precursor in the uncharged state is charged, theoretically, the charge amount required for all the lithium reactive materials contained per unit area of the negative electrode intermediate layer to react with lithium ions is the capacity Cₓ [mAh/cm²]. In the present description, as the value of the capacity C. [mAh/cm²], a value calculated by multiplying the capacity per unit mass of each material of the lithium reactive material contained per unit area of the negative electrode intermediate layer by the mass of the lithium reactive material contained per unit area of the negative electrode intermediate layer is employed. The capacity per unit mass of each material is determined by the following method. A sample A that is a lithium reactive material to be measured is weighed in an amount of 0.1 g, placed in a sleeve (Φ10) made of SLD, sandwiched at both ends by SLD pins plated with hard Cr, and pressed at room temperature (25° C.) at a pressure of 390 MPa for 1 minute to prepare pellets A made of the sample A. In addition, 0.1 g of Li₆PS₅Cl as a solid electrolyte is weighed, and solid electrolyte pellets are prepared by the same method as described above. SUS foil as a current collector, pellets A, solid electrolyte pellets, lithium metal as a counter electrode, and SUS foil as a current collector are sequentially laminated to produce a half cell for capacity measurement. Lithium ions are transferred from lithium metal to the pellets A by performing charging at a constant current of 1.5 [mA/cm²] at a temperature of 60° C. while applying a confining pressure of 3 MPa in the lamination direction of the half cell for capacity measurement using a pressurizing member. The behavior of the cell voltage at this time is measured, and the current capacity [mAh] of the lithium reactive material is determined from the behavior. The cut-off voltage varies depending on the type of the lithium reactive material, but a portion where the cell voltage sharply decreases is taken as the cut-off voltage. The value obtained by dividing the product of the time T(h) from the start of charging to the cut-off and the constant charging current 1.5 [mA/cm²] by the mass (0.1 g) of the sample A used for the measurement is the capacity per unit mass [mA/(g·cm²)] of the sample A. The product of the mass M(g) of the lithium reactive material contained per unit area of the negative electrode intermediate layer and the capacity per unit mass [mA/(g·cm²)] of each material obtained as described above is defined as Cₓ [mAh/cm²]. When two or more types of lithium reactive materials are contained in the negative electrode intermediate layer, the capacity per unit mass is obtained by the above method for each material, and the product of the capacity and the mass of each material contained per unit area of the negative electrode intermediate layer is calculated. Then, the capacity Cₓ [mAh/cm²] can be obtained by summing the products calculated for all the materials.

In the formula 1, C₁ represents the capacity [mAh/cm²] of the all-solid state battery precursor at the end point of the first charging step. C₂ represents the capacity (unit: [mAh/cm²]) of the all-solid state battery precursor at the start point of the second charging step. The capacity of the all-solid state battery precursor in the uncharged state is 0 [mAh/cm²].

“0.8×Cₓ [mAh/cm²]≤{C₁ [mAh/cm²]” in the formula 1 means that the first charging step is performed such that the capacity C₁ of the all-solid state battery precursor at the end point of the first charging step is 80% (0.8×Cₓ) or more of the capacity Cₓ of the lithium reactive material contained per unit area of the negative electrode intermediate layer. When 0.8×Cₓ [mAh/cm²]>C₁ [mAh/cm²], the second charging step (charging at a relatively high rate) is started in a state where the reaction between the lithium reactive material contained in the negative electrode intermediate layer and lithium ions does not sufficiently proceed. In such a case, the lithium-ion conductivity of the negative electrode intermediate layer may be non-uniform, or the strength of the negative electrode intermediate layer may be non-uniform. As a result, there is a risk of failing to sufficiently suppress the growth of dendrites from the lithium metal (negative electrode active material layer). From such a viewpoint, in “0.8×Cₓ [mAh/cm²]≤C₁ [mAh/cm²]”, 0.8, which is the coefficient of 0.8×Cₓ may be a value closer to 1. That may be “0.9×Cₓ <C₁”, “0.95×Cₓ<C₁”, “0.98×Cₓ {C₁”, or “1×Cₓ {C₁” (the unit is omitted). On the other hand, from the viewpoint of shortening the charging time in the production step, the time required for the first charging step is preferably shorter. Therefore, from this viewpoint, “0.8×Cₓ=C₁” may be preferable. It may be “0.9×Cₓ=C₁”, “0.95×Cₓ=C₁”, “0.98×Cₓ=C₁”, or “1×Cₓ=C₁” (the unit is omitted).

“C₁ [mAh/cm²]<C₂[mAh/cm²]” in the formula 1 means that the capacity C₂ of the all-solid state battery precursor at the start point of the second charging step is equal to or more than the capacity C₁ of the all-solid state battery precursor at the end point of the first charging step. From the viewpoint of shortening the charging time in the production step, it may be preferable that no other charging step and/or discharging step is included between the first charging step and the second charging step. That is, the second charging step may be performed subsequent to the first charging step (however, a pausing step may be included between the first charging step and the second charging step). In this case, the above relationship is “C₁=C₂”.

Thus, in one embodiment, the formula 1 may be “0.9×Cₓ=C₁=C₂”, “0.95×Cₓ=C₁=C₂”, “0.98×Cₓ=C₁=C₂”, or “1×Cₓ =C₁=C₂” (unit omitted).

In the formula 2, I₁ represents the maximum value (unit: [mA/cm²]) of the current density in the first charging step. The current density in the first charging step may be constant or may change. From the viewpoint of shortening the charging time in the production step, the current density in the first charging step may be constant (that is, the current density remains constant at I₁).

In the formula 2, 12 represents the minimum value (unit: [mA/cm²]) of the current density in the second charging step. The current density in the second charging step may be constant or may change. From the viewpoint of shortening the charging time in the production step, the current density in the second charging step may be constant (that is, the current density remains constant at I₂).

In the production method according to the present embodiment, it may be preferable that the maximum value I₁ of the current density in the first charging step further satisfies the following formula 3.

$${I}_{1} [ mA / {cm}^{2} ] < 8 \times {I}_{x} [ mA / {cm}^{2} ] \qquad Formula 3$$

In the formula 3, Iₓ represents the current density (unit: [mA/cm²]) that takes one hour to charge the capacity Cₓ [mAh/cm²]. Herein, Cₓ is the same as the definition described in the above formula 1, and I₁ is the same as the definition described in the above formula 2. Therefore, in other words, the formula 3 means that the first charging step is performed at such a current density with which it takes longer than ⅛ hours (7.5 minutes) to charge the capacity Cₓ of the lithium reactive material contained per unit area of the negative electrode intermediate layer. By performing the first charging step at such a low rate, lithium-ion conductivity is more uniformly imparted to the negative electrode intermediate layer, and the lithium metal (negative electrode active material layer) deposited thereafter becomes more uniform. In addition, since the strength in the negative electrode intermediate layer is also even more uniform, even when minute dendrites are generated in the lithium metal (negative electrode active material layer), the growth thereof is suppressed. Therefore, in the lithium deposition type all-solid state battery, it is possible to further suppress short circuits. From the same viewpoint, the maximum value I₁ of the current density in the first charging step and the minimum value I₂ of the current density in the second charging step may satisfy the following formula 4, or formula 5.

$${I}_{1} [ mA / {cm}^{2} ] \leq 5 \times {I}_{x} [ mA / {cm}^{2} ] \qquad Formula 4$$

$${I}_{2} [ mA / {cm}^{2} ] \leq 10 \times {I}_{x} [ mA / {cm}^{2} ] \qquad Formula 5$$

In the production method according to the present embodiment, in the stage 2, as long as the first charging step and the second charging step as described above are included, another charging step may be further included. However, from the viewpoint of shortening the charging time in the production step, it may not include another charging step and/or discharging step between the first charging step and the second charging step or after the second charging step. That is, it may be preferable that the all-solid state battery precursor is charged from the uncharged state (capacity 0 [mAh/cm²]) to the capacity C₁ [mAh/cm²] in the first charging step, and then the all-solid state battery precursor is charged from the capacity C₁ (=C₂) [mAh/cm²] in the second charging step (however, a pausing step may be included between the first charging step and the second charging step). Further, it may perform charging to a fully charged state (SOC 100%) by the second charging step.

In the production method according to the present embodiment, from the viewpoint of exerting a more reliable short-circuit suppression effect in the lithium deposition type all-solid state battery, it may be preferable that in the initial charging step of the stage 2, charging is performed only by the first charging step and the second charging step described above; 1×Cₓ=C₁=C₂ is satisfied; and the current density in the first charging step and the current density in the second charging step are each constant. That is, according to one embodiment, there is provided a production method in which an initial charging step performed on an all-solid state battery precursor having the same configuration as that of the all-solid state battery and in an uncharged state only includes the first charging step of charging to the capacity Cₓ [mAh/cm²] and the second charging step of charging the all-solid state battery precursor subjected to the first charging step from the capacity Cₓ [mAh/cm²], and the current density in the first charging step is constant and the current density in the second charging step is constant.

In the production method according to the present embodiment, it may perform charging while applying a confining pressure to the all-solid state battery precursor when performing the first charging step and the second charging step. That is, in the production method according to the present embodiment, it may be preferable that the all-solid state battery precursor further includes a confining member that confines the power generating element in the lamination direction, and the first charging step and the second charging step are performed in a state where the confining pressure in the lamination direction of the power generating element is 0.1 MPa or more. By charging while applying the confining pressure in this manner, lithium-ion conductivity is more uniformly imparted to the negative electrode intermediate layer, and the lithium metal (negative electrode active material layer) deposited thereafter becomes more uniform. In addition, since the strength in the negative electrode intermediate layer is also even more uniform, even when minute dendrites are generated in the lithium metal (negative electrode active material layer), the growth thereof is suppressed. Therefore, in the lithium deposition type all-solid state battery, it is possible to further suppress short circuits. From such a viewpoint, the confining pressure may be 0.2 MPa or more, 1.0 MPa or more, or 3.0 MPa or more.

### [Discharging Step]

The production method according to the present embodiment may further include a discharging step of discharging the all-solid state battery precursor that has undergone the first charging step and the second charging step, as necessary. When such a discharging step is performed, it may perform the discharging step such that the capacity of the all-solid state battery precursor does not become less than 0.8×Cₓ[mAh/cm²]. By performing the discharging step under such a condition, the subsequent charging step can be performed while maintaining the negative electrode intermediate layer formed in the first charging step described above (that is, in a state where lithium is held in the negative electrode intermediate layer and lithium-ion conductivity is secured). Thereby, the lithium metal (negative electrode active material layer) deposited in the subsequent charging step can also be made more uniform. In addition, since the strength in the negative electrode intermediate layer becomes even more uniform, even when minute dendrites are generated in the lithium metal (negative electrode active material layer) in the subsequent charging step, the growth thereof is suppressed. Therefore, in the lithium deposition type all-solid state battery, a further reliable short-circuit suppression effect can be exhibited. From such a viewpoint, it may perform the discharging step such that the capacity of the all-solid state battery precursor does not become less than 0.9×Cₓ [mAh/cm²], less than 0.95×Cₓ, less than 0.98×Cₓ, or less than 1×Cₓ.

The following embodiments are also included in the scope of the present invention: the production method according to claim 1 having the feature of claim 2; the production method according to claim 1 having the feature of claim 3; the production method according to any one of claims 1 to 3 having the feature of claim 4; the production method according to any one of claims 1 to 4 having the feature of claim 5; the production method according to any one of claims 1 to 5 having the feature of claim 6; and the production method according to any one of claims 1 to 6 having the feature of claim 7.

### EXAMPLES

### Preparation Example of Evaluation Cell Precursor

### [Evaluation Cell Precursor A]

### (Preparation of Positive Electrode)

In a glove box in an argon atmosphere having a dew point of −68° C. or less, LiNi_{0.8}Mn_{0.1}Co_{0.1}O₂ as a positive electrode active material, acetylene black as a conductive aid, and Li₆PS₅Cl as a solid electrolyte were weighed so as to have a mass ratio of 50:30: 20. These were mixed using an agate mortar, and then further stirred and mixed with a planetary ball mill. To 100 parts by mass of the obtained mixed powder, 2 parts by mass of styrene-butadiene rubber (SBR) as a binder was added, and mesitylene as a solvent was added and mixed to prepare a positive electrode active material slurry. The positive electrode active material slurry was applied onto the surface of aluminum foil as a positive electrode current collector, dried, and pressed to provide a positive electrode having a positive electrode active material layer (thickness: 50 μm) on the surface of the positive electrode current collector.

### (Preparation of Solid Electrolyte Layer)

In a glove box in an argon atmosphere at a dew point of −68° C. or less, 2 parts by mass of SBR as a binder was added to 100 parts by mass of Li₆PS₅Cl as a solid electrolyte, and mesitylene as a solvent was added and mixed to prepare a solid electrolyte slurry. The solid electrolyte slurry was applied onto the surface of stainless steel foil as a support and dried to provide a solid electrolyte layer (thickness: 30 μm).

### (Preparation of Negative Electrode Intermediate Layer)

Silver nanoparticles and carbon black nanoparticles were weighed so as to have a mass ratio of 1:3, and mixed. To 5 parts by mass of the obtained mixture, 0.5 parts by mass of SBR as a binder was added, and mesitylene as a solvent was added and mixed to prepare a negative electrode intermediate layer slurry. The negative electrode intermediate layer slurry was applied onto the surface of stainless steel foil as a negative electrode current collector and dried to provide a negative electrode intermediate layer (thickness: 10 μm). In plan view of the power generating element, the capacity Cₓ of the mixture of silver nanoparticles and carbon black nanoparticles contained per unit area of the negative electrode intermediate layer was 0.5 [mAh/cm²]. The current density Iₓ that takes 1 hour to charge to 0.5 [mAh/cm²] is 0.5 [mA/cm²].

### (Preparation of Evaluation Cell Precursor)

A positive electrode active material layer formed on a surface of aluminum foil (positive electrode current collector) and a solid electrolyte layer formed on a surface of stainless steel foil were superposed on each other such that an exposed surface of the positive electrode active material layer and an exposed surface of the solid electrolyte layer faced each other, and were transferred by cold isostatic pressing (CIP). After the stainless steel foil adjacent to the solid electrolyte layer was peeled off, the solid electrolyte layer and the negative electrode intermediate layer formed on the surface of the stainless steel foil (negative electrode current collector) were superposed on each other such that the exposed surface of the solid electrolyte layer and the exposed surface of the negative electrode intermediate faced each other, and were transferred by cold isostatic pressing (CIP). Finally, an aluminum positive electrode tab and a nickel negative electrode tab were joined to each of the aluminum foil (positive electrode current collector) and the stainless steel foil (negative electrode current collector) by an ultrasonic welding machine, and the obtained laminate was placed inside an aluminum laminate film and vacuum-sealed to provide an evaluation cell precursor A as a lithium deposition type all-solid state battery precursor.

### [Evaluation Cell Precursor B]

An evaluation cell precursor B was obtained in the same manner as in the evaluation cell precursor A except that the negative electrode intermediate layer was not provided (that is, in the above (Preparation of evaluation cell precursor), stainless steel foil (negative electrode current collector) on which the negative electrode intermediate layer is not formed is overlapped on the exposed surface of the solid electrolyte layer).

### Example of Initial Charging of Evaluation Cell Precursor

The following initial charging was performed at a temperature of 60° C. while applying a confining pressure of 3 MPa in the lamination direction of the evaluation cell precursor prepared above using a pressurizing member.

### Example 1

Charging was performed at a constant current of 3.0 [mA/cm²] (=6×Iₓ) until the charge capacity reached 0.5 [mAh/cm²] (1×Cₓ) while a confining pressure of 3 MPa was applied to the evaluation cell precursor A using a pressurizing member in the lamination direction (first charging step). Thereafter, charging was performed at a constant current of 6.0 [mA/cm²] (=12×Iₓ) until the voltage reached 4.3 V (second charging step), and the charge capacity at this time was measured. Then, a value obtained by summing the charge capacity of 0.5 [mAh/cm²] in the first charging step and the charge capacity in the second charging step was taken as the charge capacity of the initial charging.

### Examples 2 to 7, Comparative Examples 2 and 3

Initial charging was performed for the evaluation cell precursor A in the same manner as in Example 1 except that the confining pressure, the current density in the first charging step, and/or the current density in the second charging step were changed to the values shown in Table 1 below. As a result, an evaluation cell A after charging was obtained.

### Comparative Example 1

Charging was performed at a constant current of 1.5 [mA/cm²] (=3×Iₓ) until the charge capacity reached 0.5 [mAh/cm²] while a confining pressure of 3 MPa was applied to the evaluation cell precursor B using a pressurizing member in the lamination direction (first charging step). Thereafter, charging was performed at a constant current of 4.0 [mA/cm²] (=8×Iₓ) until the voltage reached 4.3 V (second charging step), and the charge capacity at this time was measured. Then, a value obtained by summing the charge capacity of 0.5 [mAh/cm²] in the first charging step and the charge capacity in the second charging step was taken as the charge capacity of the initial charging. As a result, an evaluation cell B after charging was obtained.

### <Evaluation of Charge-Discharge Efficiency and Rate Characteristics>

Charge-discharge efficiency and rate characteristics of each evaluation cell were evaluated under the following conditions.

First, discharging was performed for each evaluation cell after the initial charging at a constant current of 6.0 [mA/cm²] at a temperature of 60° C. until the voltage reached 2.5 V, and the discharge capacity of the initial discharging was measured. Then, the percentage of the discharge capacity of the initial discharging to the charge capacity of the initial charging was calculated, and the obtained value was taken as the charge-discharge efficiency.

Subsequently, charging was performed for each evaluation cell after the initial charging and discharging at a constant current of 0.55 [mA/cm²] at a temperature of 60° C. until the voltage reached 4.3 V, and the charge capacity at this time was measured. Thereafter, discharging was performed at a constant current of 0.55 [mA/cm²] until the voltage reached 2.5 V. Then, charging was performed at a constant current of 5.5 [mA/cm²] at a temperature of 60° C. until the voltage reached 4.3 V, and the charge capacity at this time was measured. Thereafter, discharging was performed at a constant current of 5.5 [mA/cm²] until the voltage reached 2.5 V. The proportion of the charge capacity at 5.5 [mA/cm²] to the charge capacity at 0.55 [mA/cm²] was calculated, and the obtained value was taken as the charge capacity ratio. As the value of the charge capacity ratio is larger, the rate characteristics are more excellent.

These results are shown in Table 1 below. “-” in Table 1 indicates that the measurement could not be performed due to occurrence of short circuits.

| | | | | Second | | | | | |
|---|---|---|---|---|---|---|---|---|---|
| | Capacity | | | charging | | | | | |
| | Cₓ of Li | First charging step | | step | | | Charge- | | |
| | reactive | Current | Charge | Current | Confining | | discharge | Charge | |
| | material | density | capacity C₁ | density | pressure | Short | efficiency | capacity | |
| | [mAh/cm²] | [mA/cm²] | [mAh/cm²] | [mA/cm²] | [MPa] | circuits | [%] | ratio | Remarks |
| Example 1 | 0.5 | 3.0 | 0.5 | 6.0 | 3 | Without | 92.1 | 0.82 | I₁ = 6 × Iₓ |
| | | | | | | | | | I₂ = 12 × Iₓ |
| Example 2 | 0.5 | 1.5 | 0.5 | 6.0 | 3 | Without | 92.4 | 0.9 | I₁ = 3 × Iₓ |
| | | | | | | | | | I₂ = 12 × Iₓ |
| Example 3 | 0.5 | 3.0 | 0.5 | 4.0 | 3 | Without | 92.1 | 0.86 | I₁ = 6 × Iₓ |
| | | | | | | | | | I₂ = 8 × Iₓ |
| Example 4 | 0.5 | 1.5 | 0.5 | 4.0 | 3 | Without | 92.6 | 0.93 | I₁ = 3 × Iₓ |
| | | | | | | | | | I₂ = 8 × Iₓ |
| Example 5 | 0.5 | 1.5 | 0.5 | 4.0 | 0.2 | Without | 92.7 | 0.91 | I₁ = 3 × Iₓ |
| | | | | | | | | | I₂ = 8 × Iₓ |
| Example 6 | 0.5 | 1.5 | 0.5 | 4.0 | 0.1 | Without | 91.6 | 0.84 | I₁ = 3 × Iₓ |
| | | | | | | | | | I₂ = 8 × Iₓ |
| Example 7 | 0.5 | 1.5 | 0.5 | 4.0 | 0.05 | Without | 85.2 | 0.68 | I₁ = 3 × Iₓ |
| | | | | | | | | | I₂ = 8 × Iₓ |
| Comparative | | 1.5 | 0.5 | 4.0 | 3 | With | — | — | No negative |
| Example 1 | | | | | | | | | intermediate |
| | | | | | | | | | layer |
| Comparative | 0.5 | 4.0 | 0.5 | 4.0 | 3 | With | — | — | I₁ = I₂ |
| Example 2 | | | | | | | | | |
| Comparative | 0.5 | 1.5 | 0.25 | 4.0 | 3 | With | — | — | C₁ = 0.5 × Cₓ |
| Example 3 | | | | | | | | | |

From the results in Table 1, it is found that according to one or more embodiments of the present invention, short circuits can be more reliably suppressed in a lithium deposition type all-solid state battery.

From comparison between Example 1 and Example 3, it is found that when I₁ [mA/cm²]≤5×Iₓ [mA/cm²] is further satisfied, the charge capacity ratio increases (rate characteristics are improved). In addition, from comparison between Example 1 and Example 2, it is found that when I₂ [mA/cm²]≤10×Iₓ [mA/cm²] is further satisfied, the charge capacity ratio increases (rate characteristics are improved). These are considered to be because the growth of dendrites is further suppressed, whereby an increase in internal resistance due to reductive decomposition of the solid electrolyte or the like is suppressed. Further, from comparison among Example 2, Example 3, and Example 4, it is found that when I₁ [mA/cm²]≤5×Iₓ [mA/cm²] and I₂ [mA/cm²]≤10×Iₓ [mA/cm²] are satisfied, the charge capacity ratio further increases (rate characteristics are improved).

From comparison among Examples 4 to 7, it is found that as the confining pressure increases, the charge-discharge efficiency tends to increase, and the charge capacity ratio increases (rate characteristics are improved). This is considered to be because the electrochemical reaction between lithium ions and the lithium reactive material contained in the negative electrode intermediate layer more uniformly proceeds, whereby the lithium conductivity of the negative electrode intermediate is improved, and lithium metal is uniformly deposited between the negative electrode intermediate and the negative electrode current collector.

### REFERENCE SIGNS LIST

10a Laminate type secondary battery
11′ Negative electrode current collector
11″ Positive electrode current collector
13 Negative electrode active material layer
14 Negative electrode intermediate layer
15 Positive electrode active material layer
17 Solid electrolyte layer
19 Single battery layer
21 Power generating element
25 Negative electrode current collecting plate
27 Positive electrode current collecting plate
29 Laminate film

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A method for producing an all-solid state battery, the all-solid state battery comprising:
a positive electrode;
a negative electrode comprising a negative electrode current collector;
a solid electrolyte layer interposed between the positive electrode and the negative electrode; and
an intermediate layer interposed between the negative electrode current collector and the solid electrolyte layer, wherein the intermediate layer comprises at least one type of a lithium reactive material, wherein:
the method comprises:
performing a first charging step on an uncharged all-solid state battery from an uncharged state to a capacity C₁ [mAh/cm²], thereby forming an all-solid state battery precursor; and
performing a second charging step on the all-solid state battery precursor from the capacity C₁ to a capacity C₂ [mAh/cm²], thereby forming the all-solid state battery, wherein:
when a capacity of the lithium reactive material contained per unit area of the intermediate layer in plan view of the all-solid state battery is Cₓ [mAh/cm²], a maximum value of a current density in the first charging step is I₁ [mA/cm²], and a minimum value of a current density in the second charging step is I₂ [mA/cm²], 0.8×Cₓ [mAh/cm²]≤C₁ [mAh/cm²]≤C₂ [mAh/cm²], and I₁ [mA/cm²]<I₂ [mA/cm²] are satisfied.

2. The method for producing the all-solid state battery according to claim 1, wherein I₁ [mA/cm²]<8×Iₓ [mA/cm²], and wherein Iₓ [mA/cm²] is a current density that takes one hour to charge to the capacity Cₓ [mAh/cm²].

3. The method for producing the all-solid state battery according to claim 1, wherein I₁ [mA/cm²]≤5×Iₓ [mA/cm²], and wherein Iₓ [mA/cm²] is a current density that takes one hour to charge to the capacity Cₓ [mAh/cm²].

4. The method for producing the all-solid state battery according to claim 1, wherein I₂ [mA/cm²]≤10×Iₓ [mA/cm²], and wherein Iₓ [mA/cm²] is a current density that takes one hour to charge to the capacity Cₓ [mAh/cm²].

5. The method for producing the all-solid state battery according to claim 1, comprising an initial charging consisting of the first charging step and the second charging step, wherein:
the first charging step is performed to the capacity Cₓ [mAh/cm²] and the second charging step is performed from the capacity Cₓ [mAh/cm²];
the current density in the first charging step is constant; and
the current density in the second charging step is constant.

6. The method for producing the all-solid state battery according to claim 1, wherein:
the first charging step is performed with a confining member that confines the uncharged all-solid state battery in a lamination direction in a state where a confining pressure in the lamination direction is 0.1 MPa or more; and
the second charging step is performed with the confining member that confines the all-solid state battery precursor in the lamination direction in the state where the confining pressure in the lamination direction is 0.1 MPa or more.

7. The method for producing the all-solid state battery according to claim 1, further comprising discharging the all-solid state battery subjected to the second charging step, thereby forming the all-solid state battery, wherein:
a capacity of the all-solid state battery subjected to the discharging is not less than 0.8×Cₓ [mAh/cm²].
